(19) United States
(12) Patent Application Publication
(10) Pub. No.: US 2026/0180222 A1
(43) Pub. Date: Jun. 25, 2026

(54) POWER CONNECTOR WITH IMPROVED FLOATING POWER TERMINALS

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/402,045

(22) Filed: Nov. 26, 2025

(30) Foreign Application Priority Data
Dec. 20, 2024 (TW) 113150050

(51) Int. Cl. H01R 13/04

(52) U.S. Cl. CPC H01R 13/04

(57) ABSTRACT

A power connector assembly includes: a female connector including a crown spring terminal, and a male connector including a male terminal including a mating member, a supporting member, a fixing member, and a first elastic member including a second blocking portion. The mating member includes a contacting portion for being inserted into the crown spring terminal and a first blocking portion. The supporting member includes a mounting portion and a receiving space. The mating and the fixing member are connected by a connecting portion, the connecting portion passes through the receiving space, the first elastic member is disposed between the first blocking portion and the front face of the supporting member to allow the mating member to float in a front-rear direction, and a gap is maintained between the connecting portion and an inside of the receiving space to allow the mating member to move in a radial direction.

### BACKGROUND OF THE INVENTION

### 1. Field of the Invention

The present invention relates to a power connector with a floating power terminals, especially to floating plug terminals.

### 2. Description of Related Arts

China Utility Model CN219959582U discloses a connector includes a female connector and a male connector. The female connector includes a shell and a connecting member with a receptacle hole. The connecting piece is floatingly fixed in a through hole defined on the shell. Two spring gasket are arranged at the front face and the rear face of the shell respectively. Two blocks are assembled at opposite faces of the shell, so that the spring gasket is located between the block and the front or rear face of the shell. The spring gaskets provide elastic forces that allow the connecting piece to float in a mating direction. The male connector has a plug post un-floatingly retained on a housing. This type of female connector sometimes does not meet requirements of connectors in certain scenarios.

Therefore, it is desirable to design an improved power connector to overcome the aforementioned shortcomings.

### SUMMARY OF THE INVENTION

An object of the present invention is to provide a power connector with improved floating terminals.

To achieve the above-mentioned object, a power connector assembly comprises: a female connector comprising a crown spring terminal; and a male connector comprising a male terminal, the male terminal comprising a mating member, a supporting member, a fixing member, and a first elastic member, the mating member comprising a contact portion extending forward for being inserted into the crown spring terminal and a first blocking portion, the supporting member comprising a mounting portion and a receiving space penetrating through a front face and a rear face thereof, the fixing member comprising a second blocking portion, wherein the mating member and the fixing member are connected with each other by a connecting portion, the connecting portion passes through the receiving space, the first elastic member is disposed between the first blocking portion and the front face of the supporting member to allow the mating member to float in a front-rear direction, and a gap is maintained between the connecting portion and an inside of the receiving space to allow the mating member to move in a radial direction perpendicular to the front-rear direction.

Other advantages and novel features of the invention will become more apparent from the following detailed description of the present embodiment when taken in conjunction with the accompanying drawings.

### BRIEF DESCRIPTION OF DRAWINGS

FIG. 1 is a perspective view of a power connector according to a first embodiment of the present invention;

FIG. 2 is another perspective view of the power connector in FIG. 1;

FIG. 3 is a cross-sectional view of the power connector along line A-A in FIG. 1 and a partial enlarged view;

FIG. 4 is a partial cross-sectional view of the power connector along line B-B in FIG. 1;

FIG. 5 is an exploded perspective view of the power connector in FIG. 2;

FIG. 6 is an exploded perspective view of the power terminal in FIG. 5;

FIG. 7 is another exploded perspective view of the power terminal in FIG. 6;

FIG. 8 is a perspective view of a power connector according to a second embodiment of the present invention;

FIG. 9 is another perspective view of the power connector in FIG. 8;

FIG. 10 is an exploded perspective view of the power connector in FIG. 8;

FIG. 11 is an exploded perspective view of the power terminal in FIG. 10;

FIG. 12 is a perspective view of the first, second, and third elastic members in FIG. 11;

FIG. 13 is a perspective view of the first and second elastic members in FIG. 12;

FIG. 14 is a perspective view of the third elastic member in FIG. 12;

FIG. 15 is a cross-sectional view of the power connector along line C-C of FIG. 8;

FIG. 16 is a perspective view of the first, second, and third elastic members and the supporting member;

FIG. 17 is a cross-sectional schematic view of an initial stage of mating between the power connector and the first external component;

FIG. 18 is a cross-sectional schematic view of an intermediate stage of mating between the power connector and the first external component; and

FIG. 19 is a cross-sectional schematic view of a final stage of mating between the power connector and the first external component.

### DETAILED DESCRIPTION OF THE PREFERRED EMBODIMENT

Reference will now be made to the drawing figures to describe the preferred embodiment of the present invention in detail.

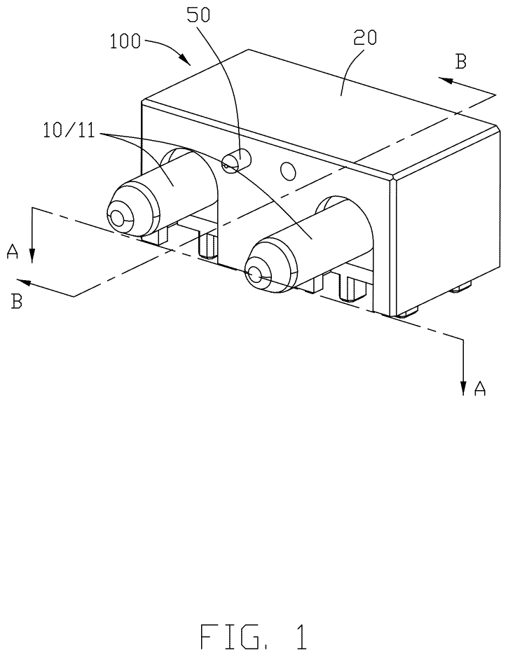

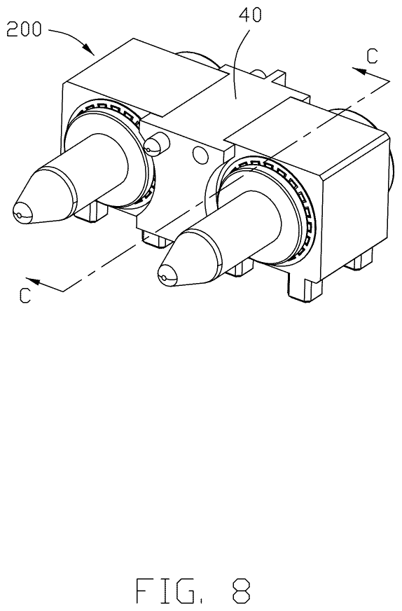

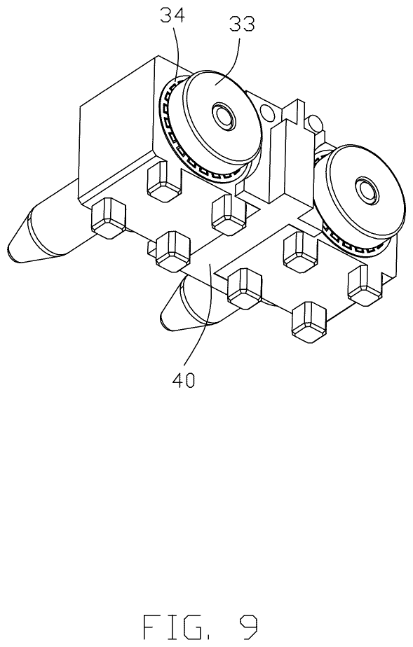

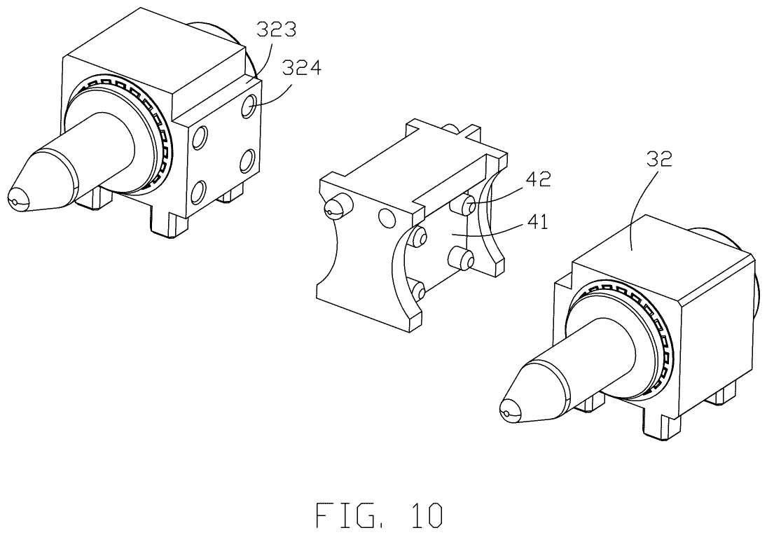

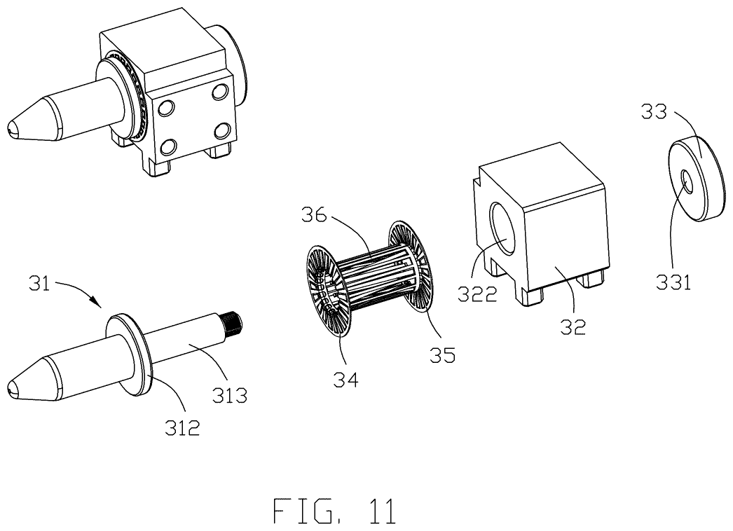

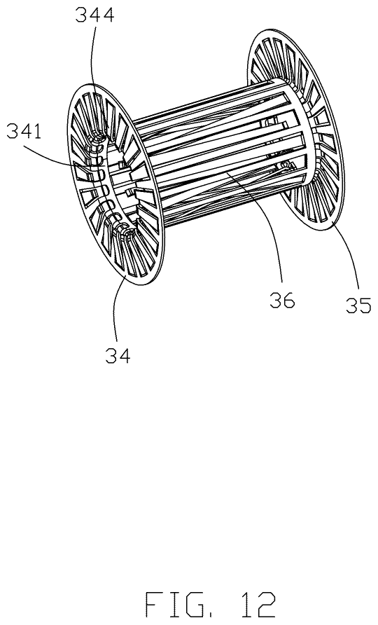

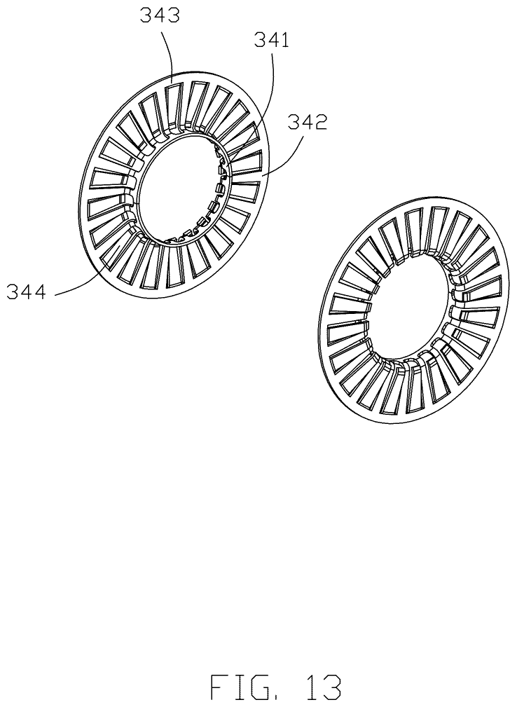

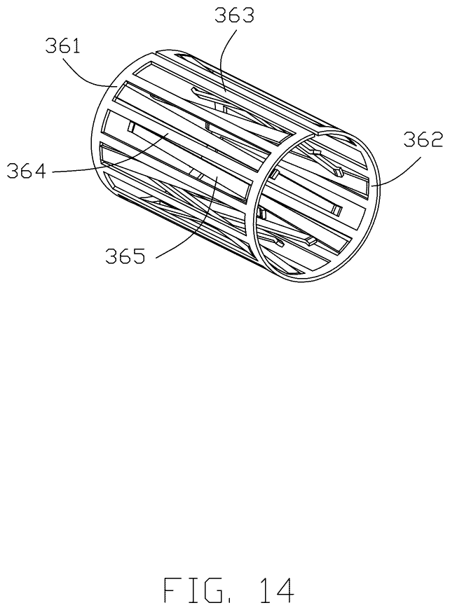

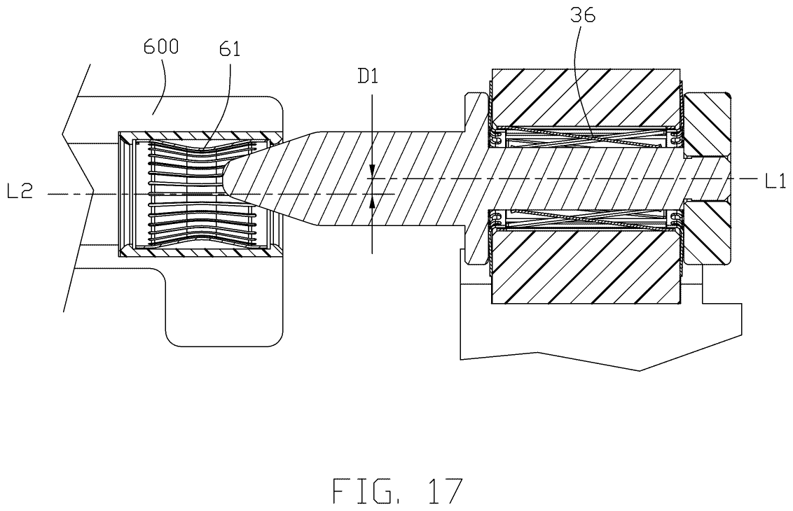

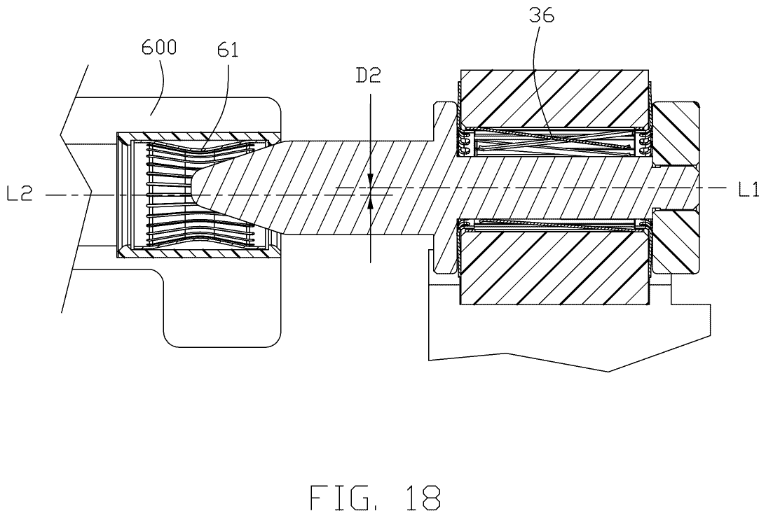

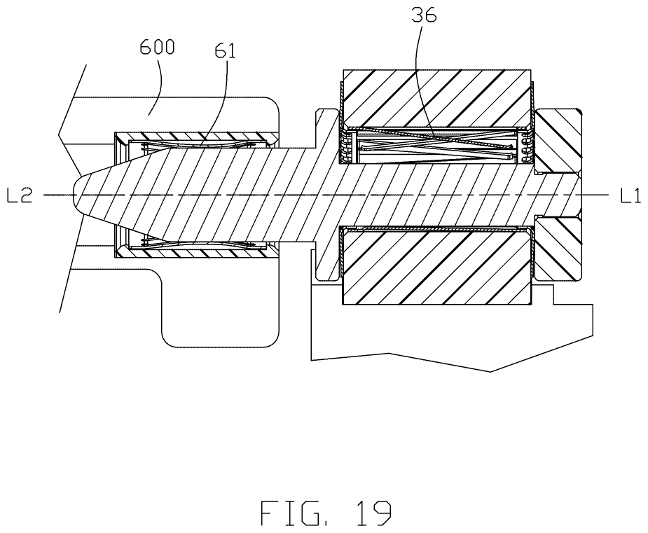

A power connector is designed for transmitting high current, with a capacity of up to 110 amperes. FIG. 1 to FIG. 7 illustrate a first embodiment of the power connector 100, and FIG. 8 to FIG. 19 illustrate a second embodiment of the power connector 200. The power connectors 100, 200 in the two embodiments are of a male/plug power connector with a columnar plug, i.e., a columnar contact portion 111 described below. The power connector is used to electrically connect a first external component 600 and a second external component. The first external component 600 can be a receptacle power connector mounted on a bus-bar, such as a copper bus-bar, and typically contains a crown spring terminal 61, as shown in FIGS. 17 to 19. The columnar plug is inserted into and makes elastic contact with the crown spring terminal 61. The second external component can be a power-transmitting bus-bar, rigid circuit board, flexible circuit board, cable, etc. The power connector is generally fixedly mounted on the second external component.

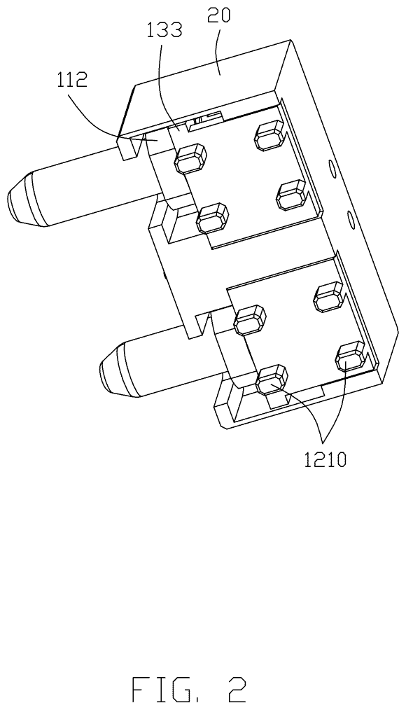

As shown in FIGS. 1-2, the power connector 100 includes two power terminals 10 and an insulator 20 sleeved over the two power terminals 10. The insulator 20 is used for securing the power terminals 20 and also provides an insulation from the two power terminals for reducing high-voltage electrical sparks produced therebetween. The two power terminals 20 serve as a positive pole and a negative pole, respectively. For simple description, a mating end in a mating direction of the power connector is defined as a front end.

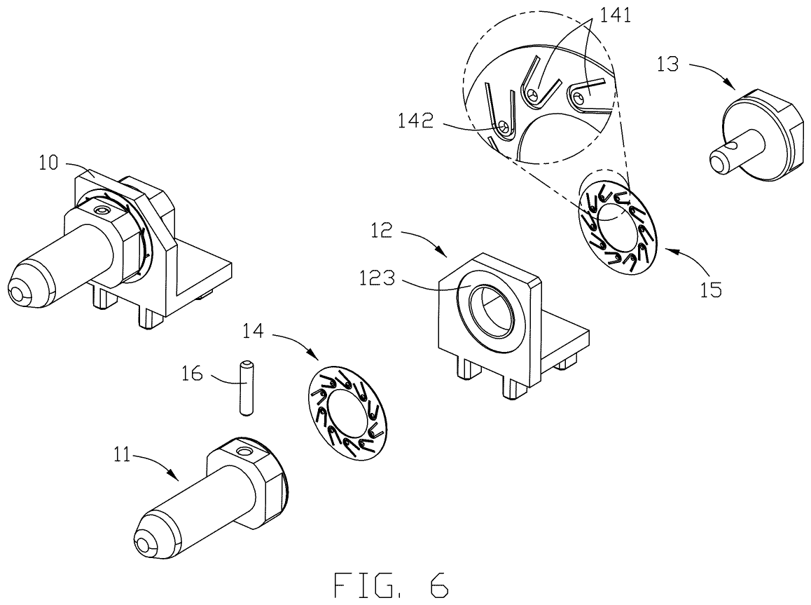

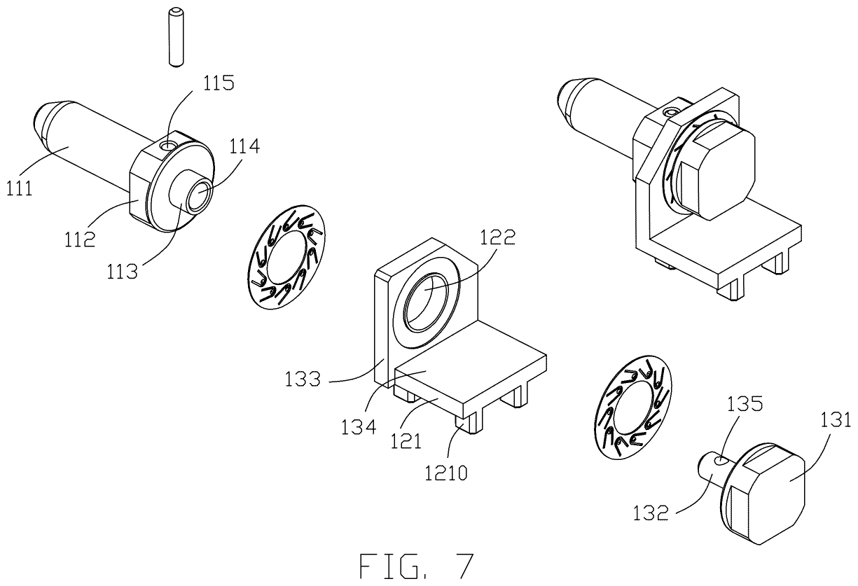

As shown in FIGS. 6-7, each of the two power terminals 10 includes a mating member 11, a supporting member 12, and a fixing member 13 assembled together as a whole. The mating member 11 includes the columnar contact portion 111 extending forward and a first blocking portion 112. The contact portion 111 is used to be inserted into the first external component 600. In this embodiment, the contact portion 111 is cylindrical, with a conical front end serving as a guiding feature, i.e., a plug post. The diameter of the first blocking portion 112 is larger than that of the contact portion 111, forming a flange structure. The contact portion 111 extends forward from a front face of the first blocking portion 112. The supporting member 12 includes a mounting portion 121 and a receiving space 122. The mounting portion 121 is used to be fixed to the second external component. In this embodiment, the mounting portion 121 has four leg portions 1210 extending downward from a bottom of the supporting member 12. The receiving space 122 penetrates through a front face and a rear surface of the supporting member 12. The fixing member 13 includes a second blocking portion 131.

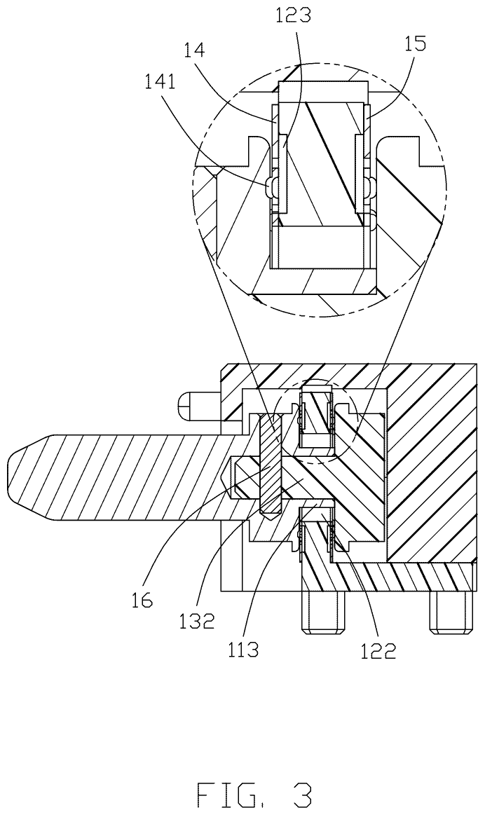

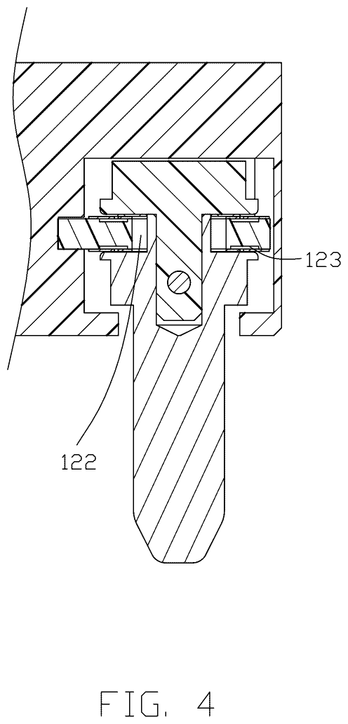

As shown in FIGS. 3-4, the mating member 11 and the fixing member 13 are secured to each other through a connecting portion 113. The connecting portion 113 passes through the receiving space 122, thereby mounting the mating member 11 onto the supporting member 12. A certain gap is maintained between the connecting portion 113 and the inside of the receiving space 122, forming a floating space. Furthermore, a first elastic member 14 is disposed between the first blocking portion 112 and the front face of the supporting member 12, and a second elastic member 15 is disposed between the second blocking portion 131 and the rear face of the supporting member 12. Therefore, the mating member 11 can float in a front-rear direction, i.e., the mating direction, achieving a reset function. In other embodiments, only the first elastic member 14 is disposed between the first blocking portion 112 and the front face of the supporting member 12 without the second elastic member, or only the second elastic member 15 is disposed between the second blocking portion 131 and the rear surface of the supporting member 12 without the first elastic member, as long as the requirement for front-rear floating is met. It should be understood that the distance between the first blocking portion 112 and the second blocking portion 131 is greater than the distance between the first and second elastic members, thereby achieving the front-rear floating effect. With the gap between the connecting portion 113 and the inside of the receiving space 122, when the contact portion 111 is inserted into the crown spring terminal 61 of the first external component, the mating member 11 can slightly float at multiple angles during the elastic matching process with the crown spring terminal 16. This ensures good contact and helps prevent damage caused by improper external forces or forced collisions after mating.

In this embodiment, the connect portion 113 extends rearward from the first blocking portion 112. A connecting hole 114 extends rearward through the connecting portion 113. The fixing member 13 includes a connecting post 132 extending forward from the second blocking portion 131. The second blocking portion 131 and the connecting post 132 are equipped with aligned fixing holes 115 and 135. The connecting post 132 is inserted into the connecting hole 114, and a fixing pin 16 radially passes through the fixing holes 115 and 135 of the first blocking portion 112 and the connecting post 132, thereby securing the connecting post 132 within the connecting hole 114. Therefore, the mating member 11 is fixed to the supporting member 12 via the fixing member 13, forming the power terminal. The mating member 11 can float at multiple angles. In other embodiments, the connecting post 132 and the connecting hole 114 can be secured using a threaded connection.

In this embodiment, the supporting member 12 is L-shaped and includes a vertical portion 133 and a horizontal portion 134. The receiving space 122 penetrates through the vertical portion 133 in the mating direction, and the horizontal portion 134 has multiple leg portions 1210 extending downward, thereby forming a right-angled power terminal. In this embodiment, the supporting member 13 is made of a copper block, and the leg portions 1210 are tin-plated legs. In other embodiments, the leg portions can be omitted, and the horizontal portion 134 can be secured to the second external component using screws.

The first and second elastic members 14, 15 have identical structures with an annular gasket, and are respectively fixed to the front and rear faces of the supporting member 12, respectively. Each of the two elastic members is stamped with a plurality of elastic fingers 141, and the elastic finger 141 has contact protrusion 142 at a distal end thereof. The contact protrusions 142 extend beyond a plane of the annular gasket. Each of the front face and the rear face of the supporting member 13 has a shallow recess 123 around the receiving space 122 to accommodate the movement of the elastic fingers 141 after compression. The elastic fingers 141 can also be inclined and offset from the plane of the annular gasket. In this embodiment, the contact protrusions may not be necessary, nor are the shallow recesses 123 required. However, the gap between the first/second blocking portion and the supporting member, needs to be increased, and the elastic fingers press against the first and second blocking portions. In this embodiment, the elastic fingers are arranged at an angle to the radial direction of the annular gasket, thereby increasing the length of the elastic fingers for enhancing elasticity. The annular gasket can be further secured to the supporting member 12 using various methods such as laser spot welding, resistance welding, adhesive bonding, or other suitable fixing techniques.

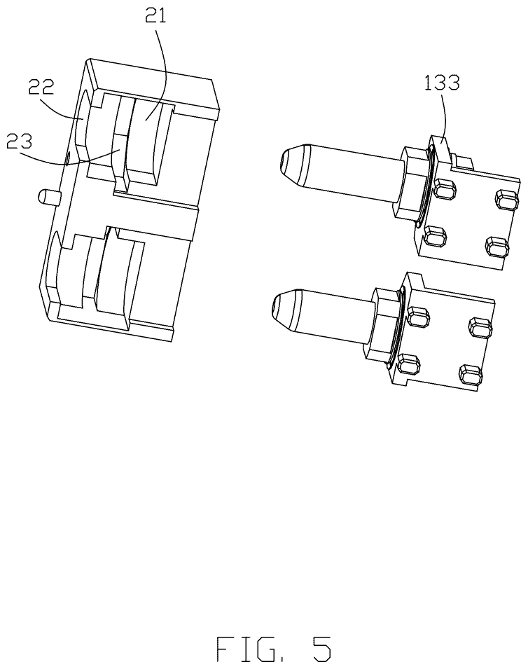

As shown in FIG. 5, the insulator 20 includes two receiving cavities 21 opening downward, two front openings 22 located in front of corresponding receiving cavity. The inside of the receiving cavity 21 is further recessed to form a semi-annular groove 23. The entire power terminal 10 is housed within the receiving cavity 21, and the contact portion 111 extends forward through the front opening 22, protruding from the front face of the insulator 20. The vertical portion 133 of the supporting member is engaged in the semi-annular groove 23 to further define the fixed relationship between the insulator 20 and the power terminal 10. The first and second blocking portions have a hexagonal nut shape, which can further prevent improper rotational movement between the insulator 20 and the power terminals 10. A pin-shaped signal terminal 50 is provided in the insulator 20, generally located above and between the two power terminals 20. The signal terminal 50 is used for detection and is the shortest in length. The system only starts the power transmission when the signal terminal 50 comes to contact with the first external component.

As shown in FIGS. 8-16, a power connector 200 of the second embodiment is illustrated, which is similar to the first embodiment. Only the differences will be highlighted hereinafter. The insulator 40 is located between the two power terminals 30, primarily serving as an electrical insulation barrier. The structure of the insulator 40 is simpler. The supporting member 32 is a block structure made of red copper, with a protruding portion 323 on one side and plural retaining holes 324 passing through the protruding portion 323. The insulator 40 has mounting cavity 41 on the left and right sides thereof, and four retaining posts 42 located in the mounting cavity 41. The protruding portion 323 is housed within the mounting cavity 41, and the retaining posts 42 are inserted into and fixed within the retaining holes 324. The other parts of the supporting member 32 are exposed to an outside the insulator 20, while the signal terminal is mounted on the insulator and extends forward and protrudes from the front face of the insulator. Therefore, the two power terminals 30 are laterally mounted on the insulator 40. The insulator 40 at the middle location provides electrical isolation, the supporting members 32 are exposed to allow the connector to have a more compact size. The insulator 40 is made of high-temperature-resistant plastic. The mating member 31 and the fixing member 33 are made of red copper, while the first and second elastic members 34, 35 are made of high-conductivity copper.

The connecting portion 313 of the mating member 31 extends rearward from the first blocking portion 312, the end of the connecting portion passes through the receiving space 322 and are interference-fitted into the fixing hole 331 on the fixing member 33. The fixing member 33 itself forms the second blocking portion, and the end of the mating member 31 and fixing hole 331 can also be secured using a threaded connection. A first elastic member 34 is disposed between the first blocking portion 312 and the front face of the supporting member 32, while a second elastic member 35 is disposed between the second blocking portion and the rear face of the supporting member, thereby allowing the mating member 31 to float in the front-rear direction. Additionally, a third elastic member 36 is sleeved around an outside of the connecting portion 313, enabling the mating member 31 to float radially. In this way, the mating member 31 achieve a floating movement in three-dimensional directions, preventing damage during mating. In this embodiment, the radial-floating movement can reach up to 1 millimeter.

The third elastic member 36 is a metal tube. The first and second elastic members 34, 35 have inner rings 341 bend therefrom respectively, the inner rings 341 extend into the receiving space 322 and press against opposite ends of the third elastic member 36, thereby forming an integrated power terminal. The third elastic member 36 includes a front ring 361, a rear ring 362, a connecting beam 363 integrally connecting the front and rear rings, plural front inclined arm 364 extending obliquely inward and rearward from the front end ring 361, and plural rear inclined arm 365 extending obliquely inward and forward from the rear ring 362. The front inclined arms 364 are located between two adjacent connecting beams 363, and the rear inclined arms 365 are located between two adjacent connecting beams 363. The front and rear inclined arms are alternately arranged. The first and second elastic members 34, 35 have identical structures of an annular gasket. The first elastic member 34 includes an inner ring 341 and an outer end ring 342, which are integrally connected by connecting beams 343. Elastic fingers 344 are formed between two adjacent connecting beams 343. The elastic fingers 344 extend obliquely and press against the front face of the supporting member 32. The inner ring 341 bends inward and presses against the front ring 361 of the third elastic member. The front and rear inclined arms are arranged in an interleaved manner and are relatively long. The front inclined arms 364 extend rearward to a position near the rear ring 362, while the rear inclined arms 365 extend forward to a position near the front ring 361, thereby increasing the compression range and allowing for greater floating capability. At the same time, the power current path and reduces temperature rise are increased. If the power current is not high, the third elastic member 36 can be omitted.

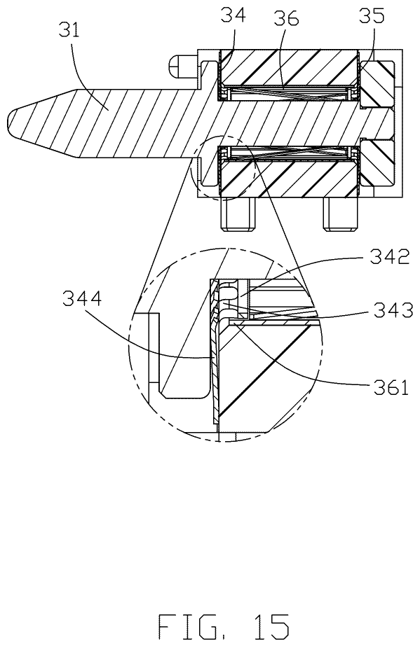

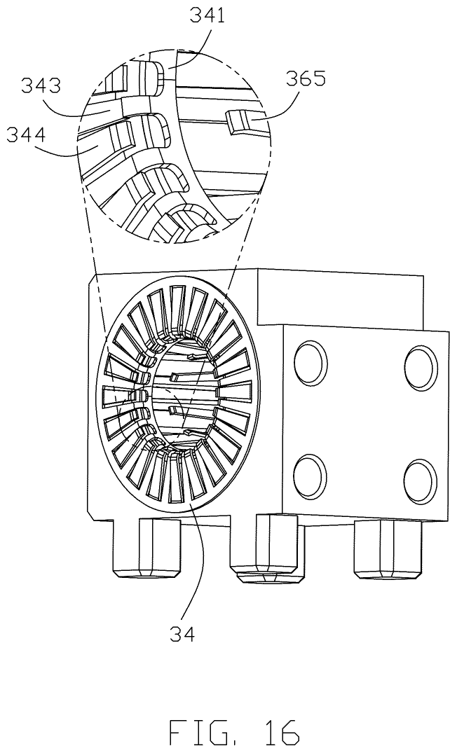

As shown in FIGS. 15-16, the elastic fingers 344 extend obliquely out of the plane of the annular gasket. The ends of the elastic fingers 344 bend inward in an arc shape, perfectly matching the chamfers at the front and rear ends of the inside of the receiving space 122, thereby providing a clearance space for the elastic fingers to retract, eliminating the need for shallow recesses.

FIGS. 17 to 19 illustrate cross-sectional schematic diagrams of the initial, intermediate, and final stages of the mating process between the power connector and the first external component 600. In the initial stage of mating, the axis L1 of the power terminal is offset from the axis L2 of the crown spring terminal by a distance D1. As the insertion progresses, the distance between the two axes decreases to D2. In the final stage, after full insertion, the two axes coincide, achieving complete mating.

The above-mentioned embodiments are only preferred embodiments of the present invention, and should not limit the scope of the present invention, any simple equivalent changes and modifications made according to the claims of the present invention and the contents of the description should still belong to the present invention.

1. A power connector assembly comprising:
a female connector comprising a crown spring terminal; and
a male connector comprising a male terminal, the male terminal comprising a mating member, a supporting member, a fixing member, and a first elastic member;
the mating member comprising a contact portion extending forward for being inserted into the crown spring terminal and a first blocking portion;
the supporting member comprising a mounting portion and a receiving space penetrating through a front face and a rear face thereof;
the fixing member comprising a second blocking portion;
wherein the mating member and the fixing member are connected with each other by a connecting portion, the connecting portion passes through the receiving space, the first elastic member is disposed between the first blocking portion and the front face of the supporting member to allow the mating member to float in a front-rear direction, and a gap is maintained between the connecting portion and an inside of the receiving space to allow the mating member to move in a radial direction perpendicular to the front-rear direction.

2. The power connector assembly as claimed in claim 1, wherein a second elastic member is fixed to the rear face of the supporting member.

3. The power connector assembly as claimed in claim 2, wherein a third elastic member is disposed between the connecting portion and the inside of the receiving space.

4. A power terminal configured to electrically connect a first external component and a second external component, the power terminal comprising:
a mating member comprising a plug post extending forward for being inserted into the first external component and a first blocking portion;
a supporting member comprising a mounting portion for being fixed to the second external component and a receiving space penetrating through a front face and a rear face thereof;
a fixing member comprising a second blocking portion; and
a first elastic member;
wherein the mating member and the fixing member are connected with each other by a connecting portion, the connecting portion passes through the receiving space, the first elastic member is disposed between the first blocking portion and the front face of the supporting member, and a gap is maintained between the connecting portion and an inside of the receiving space.

5. The power terminal as claimed in claim 4, wherein the first elastic member is fixed to the front face of the supporting member and has a plurality of elastic fingers, and the elastic fingers elastically press against the first blocking portion.

6. The power terminal as claimed in claim 5, wherein a second elastic member is fixed to the rear face of the supporting member, and the second elastic member has a plurality of elastic fingers elastically pressing against the second blocking portion.

7. The power terminal as claimed in claim 6, wherein each of the first elastic member and the second elastic member comprises an annular gasket, and the annular gaskets are fixed by laser spot welding, resistance welding, or adhesive bonding.

8. The power terminal as claimed in claim 7, wherein the elastic fingers are located within a plane of the annular gasket, each of the elastic fingers has a contact protrusion extending beyond the plane of the annular gasket, and each of the front face and rear face has a shallow recess to accommodate a movement of the elastic fingers.

9. The power terminal as claimed in claim 6, wherein a third elastic member is disposed between the connecting portion and the inside of the receiving space.

10. The power terminal as claimed in claim 9, wherein the third elastic member is of a metal tube sleeved on the connecting portion, and each of the first elastic member and the second elastic member bends to form an inner ring at one end thereof, the inner rings press opposite ends of the third elastic member against the inside of the receiving space.

11. The power terminal as claimed in claim 9, wherein the third elastic member is of a metal tube sleeved on the connecting portion, and comprises a front ring, a rear ring, a plurality of connecting beams integrally connecting with the front ring and the rear ring, a plurality of front inclined arms extending obliquely inward and rearward from the front ring, and a plurality of rear inclined arms extending obliquely inward and forward from the rear ring.

12. The power terminal as claimed in claim 11, wherein the front inclined arms extend rearward proximate to the rear ring, and the rear inclined arms extend forward proximate to the front ring.

13. The power terminal as claimed in claim 4, wherein the connecting portion extends rearward from the first blocking portion, and a distal end of the connecting portion passes through the receiving space and is fixed to a fixing hole provided on the fixing member.

14. The power terminal as claimed in claim 4, wherein:
the connecting portion extends rearward from the first blocking portion and has a connecting hole extending rearward;
the fixing member has a connecting post extending forward from the second blocking portion; and
the connecting post is inserted into the connecting hole and is secured in the connecting hole by a fixing pin radially passing through fixing holes on the first blocking portion and the connecting post.

15. The power terminal as claimed in claim 14, wherein the supporting member comprises a vertical portion and a horizontal portion, the receiving space penetrating through the vertical portion, and the horizontal portion has plural leg portions extending downward.

16. A male power connector comprising two power terminals each as claimed in claim 4 and an insulator, wherein the two power terminals are fixed within the insulator.

17. The male power connector as claimed in claim 16, wherein the power connector further includes a signal terminal disposed in the insulator.

18. The male power connector as claimed in claim 16, wherein the insulator is located between the two power terminals.

19. The male power connector as claimed in claim 16, wherein:
the insulator has mounting cavities on opposite sides thereof and plural retaining posts located within the mounting cavities;
each power terminal has a protruding portion and plural retaining holes passing through the protruding portion; and
the protruding portions are housed within the mounting cavities respectively, and the retaining posts are fixed within corresponding retaining holes.
